(19) United States
(12) Patent Application Publication
(10) Pub. No.: US 2018/0022967 A1
(43) Pub. Date: Jan. 25, 2018

(54) HALOGEN-FREE FLAME RETARDANT PRESSURE SENSITIVE ADHESIVE AND TAPE

(71) Applicant: 3M INNOVATIVE PROPERTIES COMPANY, St. Paul, MN (US)

(72) Inventors: Eumi Pyun, St. Paul, MN (US); George W. Griesgraber, Eagan, MN (US); Thu-Van Tran, Maplewood, MN (US); Tabitha A. Clem, Woodbury, MN (US); Haohao Lin, Austin, TX (US); William H. Moser, Edina, MN (US); Anthony R. Plepys, Concord, MA (US); Richard B. Ross, Cottage Grove, MN (US); David J. Yarusso, Shoreview, MN (US); Corinne E. Lipscomb, St. Paul, MN (US)

(21) Appl. No.: 15/541,058

(22) PCT Filed: Dec. 18, 2015
(86) PCT No.: PCT/US2015/066815

§ 371 Date: Jun. 30, 2017

Related U.S. Application Data
(60) Provisional application No. 62/097,695, filed on Dec. 30, 2014.
(60) Provisional application No. 62/097,707, filed on Dec. 30, 2014.

(51) Int. Cl. C09J 9/00; C08F 230/02; C08F 220/18; C09J 7/02; C09K 21/14

(52) U.S. Cl. CPC C09J 9/00; C09J 7/0217; C09K 21/14; C08F 220/18; C08F 230/02; C09J 2201/606; C09J 2433/00; C09J 133/14

(57) ABSTRACT

A halogen-free flame retardant adhesive comprises an acrylic copolymer preparable by polymerization of monomers comprising a first monomer which comprises a low glass transition temperature (Tg) monomer, a second monomer which comprises a high Tg monomer, wherein at least one of the first and second monomers comprises a (meth)acrylate, and a phosphate containing monomer.

### TECHNICAL FIELD

This disclosure relates to halogen free flame retardant adhesives and adhesive articles comprising acrylic copolymers.

### BACKGROUND

Flame retardant adhesives and tapes are used in many industries and for many different purposes. They are used, for example, in the electrical industry as insulating tapes. Many conventional flame retardant compositions, widely used as flame retardant adhesives and tapes, utilize one or more halogen-containing materials.

Pressure sensitive adhesive (PSA) tapes are used in a variety of applications with elevated fire/flame risk (aircrafts, cars, trains, ships, electrical wiring, electronics, etc.). Polymer-based PSAs can be flammable and a variety of flame retardants are used to minimize the fire/flame risk associated with the use of PSAs for specific applications. Flame retardants can reduce the flammability of materials by a variety of mechanisms including: quenching free radicals in the gas phase; reacting with chemical fragments from the burning material to initiate char formation; and forming barrier layers within the burning material.

Commonly used flame retardants include halogenated compounds (e.g. polychlorinated biphenyl and polybrominated diphenyl ethers). These flame retardants are well-known and very efficient at fire retardation in combustible materials. However, many compounds in this class of flame retardants are considered hazardous substances. Several of the most effective halogenated flame retardants have been banned by the European Union under the Restriction of Hazardous Substances (RoHS) since Jul. 1, 2006. Several Asian countries and individual states in the United States are also following with similar RoHS directives. In addition, end-product manufacturers are establishing policies to refuse to use halogenated flame retardant materials in their products.

Thus, environmental and safety concerns regarding use of halogen-containing materials in adhesives and related articles have been raised and in response to these concerns, many non-halogenated or halogen-free flame retardant materials have been introduced to be used in place of halogen-containing materials. Phosphorus-based compounds are one class of non-halogenated flame retardants which have been applied to replace halogenated flame retardants in many applications.

A current method to flame retard adhesives and additional polymeric materials is to blend halogenated or phosphorus containing flame retardant additives into the product formulation. However, a disadvantage of this approach is the flame retardant additive can leach out of the product over time. This reduces the flame retardancy of the product. It can also cause potential health and safety concerns related to exposure to harmful flame retardants that have leached out of blankets, clothing, and other commonly used items. In addition, flame retardant materials that migrate to the surface of an adhesive composition can reduce its adhesion strength. Furthermore, care must be taken in the preparation of these adhesive blends to thoroughly mix the flame retardant additive into the adhesive. If the flame retardant is poorly distributed or not miscible throughout the adhesive, regions of the adhesive having a relatively low amount of flame retardant can be less flame retardant than regions of the adhesive having a relatively higher amount of flame retardant.

### SUMMARY

Thus, it is desirable to have halogen-free flame retardant adhesives that offer flame resistant properties and also that maintain functional adhesive performance without the risk of the flame retardant leaching out. There is also a desire for articles that contain such adhesives.

In one aspect, a halogen-free flame retardant adhesive comprises an acrylic copolymer preparable by polymerization of monomers comprising a first monomer which comprises a low glass transition temperature (Tg) monomer, a second monomer which comprises a high Tg monomer, wherein at least one of the first and second monomers comprises a (meth)acrylate, and a phosphate containing monomer. Adhesives comprising copolymers of the present disclosure can be intrinsically flame retardant, with no additional flame retardant additives required.

In another aspect, a tape construction is provided that includes a support material that is substantially free of halogenated materials, has at least two major surfaces, and a flame retardant adhesive disposed on at least one major surface of the support material, wherein the flame retardant adhesive comprises an acrylic copolymer preparable by polymerization of monomers comprising a first low Tg monomer, a second high Tg monomer, wherein at least one of the first and second monomers is a (meth)acrylate, and a phosphate containing monomer.

Thus, adhesives and tapes are provided that offer desired flame retardant properties, are simple to make and use, and provide acceptable performance as an adhesive or a tape, with minimal risk of the flame retardant leaching out of the adhesive, and a better distribution of flame retardant throughout the adhesive, as the copolymerizable phosphate containing monomer is incorporated into the copolymer backbone.

The above summary is not intended to describe each disclosed embodiment of every implementation of the present disclosure. The detailed description which follows more particularly exemplifies illustrative embodiments.

### DETAILED DESCRIPTION

It is to be understood that other embodiments are contemplated and may be made without departing from the scope or spirit of the present disclosure. The following detailed description, therefore, is not to be taken in a limiting sense.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein. The use of numerical ranges by endpoints includes all numbers within that range (e.g., 1 to 5 includes 1, 1.5, 2, 2.75, 3, 3.80, 4, and 5) and any range within that range.

In this disclosure,

“halogen-free” and “nonhalogenated” are used inter-changeably herein and refer to the substantial absence, e.g., trace or ineffective amounts, of halogens, i.e., fluorine, chlorine, bromine, iodine, and astatine;

“flame retardant adhesives or tapes” refer to adhesives and tapes incorporating flame retardant materials presented herein that can pass the requirements set forth by the flame test of industry standard UL 510 (Underwriters Laboratories Inc., Eighth Edition);

“halogen-free flame retardant” and “nonhalogenated flame retardant” refer to flame retardant materials (e.g., monomers and polymers) that do not contain halogens.

“(meth)acrylate” and “(meth)acrylic” refer to compounds that contain either methacrylate or acrylate functional groups.

“acrylic copolymer” refers to a copolymer in which one or more of its constituent monomers have (meth)acrylate functional groups.

“low Tg monomer” refers to a monomer which, when polymerized to make a homopolymer having a molecular weight of at least about 10,000 g/mol, would yield a homopolymer with a glass transition temperature (Tg)<0° C.;

“high Tg monomer” refers to a monomer which, when polymerized to make a homopolymer having a molecular weight of at least about 10,000 g/mol, would yield a homopolymer with a glass transition temperature (Tg)>0° C.;

“renewable resource” refers to a natural resource that can be replenished within a 100 year time frame. The resource may be replenished naturally or via agricultural techniques. The renewable resource is typically a plant (i.e. any of various photosynthetic organisms that includes all land plants, inclusive of trees), organisms of Protista such as seaweed and algae, animals, and fish. They may be naturally occurring, hybrids, or genetically engineered organisms. Natural resources such as crude oil, coal, and peat which take longer than 100 years to form are not considered to be renewable resources.

Acceptable adhesive performance refers to meeting the requirements as set forth by the adhesion test included in ASTM D3330/D3330M-04, (Standard Test Method for Peel Adhesion of Pressure-Sensitive Tape”.

Adhesives and tape constructions are provided that are flame retardant. There are a variety of definitions and tests associated with flame retardancy. As used herein, an adhesive or a tape can be considered flame retardant when it can inhibit or resist spread of fire. According to the flame test described in the UL510 standard, in order for an adhesive or a tape test specimen to be considered flame retardant, when a test flame is applied to the test specimen, it cannot flame longer than 60 seconds following any of five 15 seconds applications of the test flame, the period between applications being: a) 15 seconds if the specimen flaming ceases within 15 seconds; orb) the duration of the specimen flaming if the specimen flaming persists longer than 15 seconds. The test specimen should not ignite combustible materials in its vicinity or damage more than 25 percent of the indicator flag during, between, or after the five applications of the test flame.

In the present invention, halogen-free flame retardant adhesives are provided that comprise an acrylic copolymer preparable by polymerization of monomers comprising the polymerization reaction product of a first low Tg monomer having a glass transition temperature (Tg)<0° C., a second high Tg monomer having a Tg>0° C., wherein at least one of the first and second monomers comprises a (meth)acrylate, and a phosphate containing monomer. In one aspect, the phosphate containing flame retardant compounds are covalently bonded into the polymer backbone, eliminating the possibility of leaching out over time. Copolymers prepared from first and second (meth)acrylic monomers, such as IOA and AA or 2OA and IBXA, and phosphate-containing monomers are demonstrated to be PSAs with suitable adhesive properties. By optimizing chemistry and structure, these types of adhesives can be formulated into PSAs with a broad range of adhesive and flame retardant properties. Combinations of more than low Tg monomer and/or more than one high Tg monomer can also be used to prepare the copolymer, to further tailor the properties of the adhesive.

In some embodiments, the adhesives of the present invention comprise acrylic copolymers that are prepared by covalently bonding a phosphate containing monomer with other constituent monomers. As a result, the phosphate flame retardant is typically more homogeneously dispersed throughout the adhesive, particularly in comparison to adhesives of the prior art that comprise a blend of a polymer and a flame retardant. Furthermore, because the flame retardant is a part of the acrylic copolymer molecule, the additional processing step of blending a flame retardant into the adhesive can be eliminated.

The first monomer used in the preparation of the acrylic copolymer can comprise a low Tg monomer, where the monomer, when polymerized to make a homopolymer having a molecular weight of at least about 10,000 g/mol, would yield a homopolymer with a Tg <0° C. In one aspect, the low Tg monomer comprises a low Tg (meth)acrylate monomer.

In some embodiments, the low Tg monomer may comprise an alkyl (meth)acrylate wherein the alkyl group contains between 4 and 12 carbon atoms, such as n-hexyl acrylate, n-butyl acrylate, isobutyl acrylate, n-octyl acrylate, 2-octyl acrylate, and lauryl acrylate. For example, the low Tg (meth)acrylate monomer may comprise isooctyl acrylate (IOA). In another example, the low Tg (meth)acrylate monomer may comprise 2-ethyl hexyl acrylate (EHA). In other embodiments, the low Tg (meth)acrylate monomer may comprise 2-octyl acrylate (2OA). Other suitable low Tg monomers can include ethyl acrylate, dimethyl amino ethyl acrylate, tridecyl acrylate, urethane acrylates, 2-ethoxy ethyl acrylate, ethoxyethoxy ethyl acrylate, 2-hydroxy ethyl acrylate, 4-hydroxy butyl acrylate, 2-methoxy ethyl acrylate, 2-phenoxy ethyl acrylate, silicone acrylates and the like, and combinations thereof.

In some aspects, the first monomer comprises the ester of (meth)acrylic acid with an alcohol derived from a renewable source. A suitable technique for determining whether a material is derived from a renewable resource is through ¹⁴C analysis according to ASTM D6866-10, as described in US2012/0288692. The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

One suitable monomer derived from a renewable source is 2-octyl (meth)acrylate, as can be prepared by conventional techniques from 2-octanol and (meth)acryloyl derivatives such as esters, acids and acyl halides. The 2-octanol may be prepared by treatment of ricinoleic acid, derived from castor oil, (or ester or acyl halide thereof) with sodium hydroxide, followed by distillation from the co-product sebacic acid. Other (meth)acrylate ester monomers that can be renewable are those derived from ethanol and 2-methyl butanol. In some embodiments, the renewable first monomer comprises a bio-based content of at least 25, 30, 35, 40, 45, or 50 wt % using ASTM D6866-10, method B. In other embodiments, the renewable first monomer comprises a bio-based content of at least 55, 60, 65, 70, 75, or 80 wt %. In yet other embodiments, the renewable first monomer comprises a bio-based content of at least 85, 90, 95, 96, 97, 99 or 99 wt- %.

In another aspect of the invention, the acrylic copolymer comprises from about 30 wt % to about 90 wt %, or from about 30 wt % to about 80 wt %, or, from about 40 wt % to about 65 wt % of the low Tg (meth)acrylic monomeric unit.

The second monomer used to prepare the acrylic copolymer can comprise a high Tg monomer, where the monomer, when polymerized to make a homopolymer having a molecular weight of at least about 10,000 g/mol, would yield a homopolymer with a Tg>0° C. In one aspect, the high Tg monomer comprises a high Tg (meth)acrylate monomer. For example, the high Tg (meth)acrylate monomer may comprise acrylic acid (AA). In another example, the high Tg (meth)acrylate monomer may comprise isobornyl acrylate (IBXA). Other suitable high Tg monomers can include methyl acrylate, methyl methacrylate, butyl methacrylate, and t-butyl acrylate, hexadecyl acrylate, ethyl methacrylate, benzyl acrylate, cyclohexyl acrylate, biphenyl ethyl acrylate, N,N-dimethyl amino ethyl methacrylate, hydroxyl ethyl methacrylate, aliphatic urethane acrylate, aromatic urethane acrylate, epoxy acrylate and the like. Suitable non-(meth)acrylic high Tg monomers include acrylamide, N,N-dimethyl acrylamide, N-vinyl pyrrolidone, vinyl acetate, N-octyl acrylamide, N-isopropyl acrylamide, t-octyl acrylamide, acrylamide, and N-vinyl caprolactam.

In another aspect of the invention, the acrylic copolymer comprises from about 1 wt % to about 40 wt %, or from about 1 wt % to about 40 wt %, or, from about 2 wt % to about 20 wt % of the high Tg (meth)acrylic monomeric unit.

The flame retardant adhesive described herein comprises an acrylic copolymer polymerizable from monomers comprising low Tg and high Tg monomers and a phosphorous containing monomer. In one aspect, the phosphorous containing monomer comprises a phosphate-based monomer. In one aspect, the phosphate-based monomer is an acrylate-functional monomer that can be represented by:

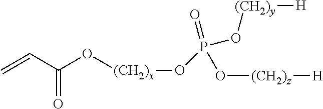

in which x, y, and z each represent an integer, x can be in the range between 1 to 5, inclusively, and y and z can be in the range between 0 to 5, inclusively. In various embodiments the values of x, y, and/or z may be either the same or different from each other. In a further aspect of the invention, the phosphate-based monomer comprises 2-diethoxyphosphoryloxyethyl acrylate (DEPEA), which can be represented by:

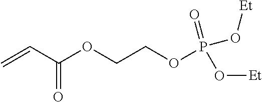

in which Et denotes an ethyl group. DEPEA can be synthesized as is described in further detail in the Examples section.

In one aspect, the phosphate-based monomer is a methacrylate-functional monomer that can be represented by:

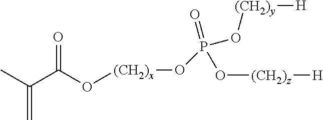

in which x, y, and z each represent an integer, x can be in the range between 1 to 5, inclusively, and y and z can be in the range between 0 to 5, inclusively. In various embodiments the values of x, y, and/or z may be either the same or different from each other. In a further aspect of the invention, the phosphate-based monomer comprises 2-diethoxyphosphoryloxyethyl methacrylate (DEPEMA), which can be represented by:

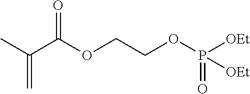

in which Et denotes an ethyl group. DEPEMA can be synthesized as is described in further detail in the Examples section. In another aspect, the phosphate-based monomer comprises phosphoric acid 2-hydroxyethyl methacrylate ester (PHME), which can be represented by:

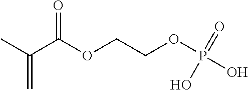

Commercially available examples of suitable PHME monomers can include those available available from Sigma-Aldrich Chemical Company, USA.

In some aspects of the invention, the acrylic copolymer comprises from about 10 wt % to about 70 wt %, or from about 20 wt % to about 60 wt %, or, from about 22 wt % to about 55 wt % of the phosphate-containing monomeric unit.

In some embodiments, the constituent monomers used to create the acrylic copolymer can also comprise a copolymerizable oligomer or macromonomer having a molecular weight between 3000 and 22,000 g/mol. In further embodiments, the macromonomer is a methyl methacrylate macromonomer having reactive vinyl end groups. Suitable macromonomers include ELVACITE 1010 and ELVACITE 1020 from Lucite International, USA. Suitable oligomers include polyester acrylate, aromatic epoxy acrylate, and aliphatic epoxy acrylate, all of which are available from Sartomer.

In addition, the halogen-free flame retardant adhesive can also comprise a copolymer that is polymerized using an initiator for initiating the polymerization process. For example, commercially available thermal initiators or commercially available UV photoinitiators can be used. In addition, commercially available solvents and cross-linkers can be included. As such, the (meth)acrylic copolymer reaction product can be formed using the polymerization processes described below and in the Examples section.

The acrylic copolymers of the present invention can be polymerized by any type of polymerization reaction commonly known in that art. The polymerization reaction can be performed in solvent or in a bulk state substantially free of solvent. In some embodiments, the acrylic copolymers are formed via free-radical polymerization. In other embodiments, the acrylic copolymers can be polymerized via a radiation process such as photopolymerization or ionized polymerization.

The amounts of each of the constituent monomers that are reacted to create the acrylic copolymer may be varied over a wide range but are present in an amount sufficient to render the adhesive or tape flame retardant while having desirable adhesive properties. As the amounts of each of the constituent monomeric units of the acrylic copolymer are changed, the performance properties such as adhesion may be adversely affected depending on the intended application for the adhesive or tape. In some embodiments, the disclosed acrylic copolymers offer desired flame retardant properties without substantially affecting functional performance of the adhesives and tapes, such as failure of adhesion to an intended surface or reduction in insulating properties of an insulating tape.

Generally, the adhesives of the present disclosure comprise at least about 70 wt % of the acrylic copolymer. The adhesives may include other additives; i.e., additives collectively accounting for less than about 30 wt % of the adhesive. Such additional components include those typically used in adhesive formulations such as fillers, dyes, pigments, stabilizers, conductive particles, plasticizers, tackifiers and the like, as understood by those skilled in the art. Materials typically categorized as tackifiers may also be present in an amount from 0 wt % to 20 wt %. Examples of tackifiers include hydrocarbon resins, such as, e.g., REGALREZ 6108 (Eastman Chemical Corporation, USA). The provided flame retardant adhesives may be used in any application in which a pressure-sensitive adhesive having a degree of flame retardancy is desired. The provided flame retardant adhesives also find particular utility in tape constructions. Such tape constructions generally comprise a support material onto which one or more functional or structural layers are applied (typically by coating). One or more of the provided flame retardant adhesives may be used in or with such tape constructions by coating or otherwise applying the adhesive onto the support material.

The provided flame retardant adhesives may be used in any application in which a pressure-sensitive adhesive having a degree of flame retardancy is desired. The provided flame retardant adhesives also find particular utility in tape constructions. Such tape constructions generally comprise a support material onto which one or more functional or structural layers are applied (typically by coating). One or more of the provided flame retardant adhesives may be used in or with such tape constructions by coating or otherwise applying the adhesive onto the support material.

In at least one embodiment of the disclosure, a multi-layered tape construction includes a flame retardant adhesive applied to a support material having at least two major surfaces. The flame retardant adhesive is provided as a layer applied to one of the major surfaces of support material. The flame retardant adhesive layer can be of any desired and workable thickness, but is generally in the range from about 20 μm to about 100 μm or even possibly more. The support material is, typically, free of halogen-containing compounds. Suitable support materials include, for example: polymer materials such as polyesters (e.g., PET (polyethylene terephthalate)), polyolefins, polyamides and polyimides; natural and synthetic rubber materials; paper materials; metal foils, glass cloths, foams, woven and nonwoven webs; and other suitable types of materials. The support material can be of any desired and workable thickness, but is generally between about 25 μm and about 125 μm thick.

### EXAMPLES

The following examples and comparative examples are offered to aid in the understanding of the present invention and are not to be construed as limiting the scope thereof. Unless otherwise indicated, all parts and percentages are by weight. The following test methods and protocols were employed in the evaluation of the illustrative and comparative examples that follow.

### Preparation of Phosphate-Containing Monomers

Unless otherwise indicated, the reagents below are commonly available from chemical suppliers such as Sigma-Aldrich Co. (USA) and Alfa Aesar (USA.)

Synthesis of 2-diethoxyphosphoryloxyethyl acrylate (DEPEA) monomer

A 3-neck 2-liter round bottom flask, equipped with a nitrogen inlet and an addition funnel, was charged with 50 mL (0.44 mol) of hydroxyethylacrylate and 400 mL of anhydrous methylene chloride. The reaction was cooled in an ice bath and 91 mL (0.65 mol) triethylamine and 1.0 g dimethylaminopyridine were added. 65 mL (0.45 mol) of diethyl chlorophosphate was dissolved in 200 mL of anhydrous methylene chloride and added to the addition funnel. This solution was added dropwise to the reaction mixture over a period of 2 h. The reaction was then allowed to warm to ambient temperature overnight and was then quenched by the addition of 400 mL of saturated NaHCO₃ solution. The mixture was transferred to a separatory funnel and the layers were separated. The organic portion was washed successively with 5% NaH₂PO₄ solution (2×200 mL), water and brine. The organic layer was dried over Na₂SO_{4,} filtered and concentrated under reduced pressure to give 106 g of the desired product as a slightly yellow liquid. The product was analyzed by proton NMR to confirm the molecular structure.

Synthesis of 2-diethoxyphosphoryloxyethyl methacrylate (DEPEMA) monomer

A 3-neck 2-liter round bottom flask, equipped with a nitrogen inlet and an addition funnel, was charged with 42 mL (0.35 mol) of hydroxyethylmethacrylate and 500 mL of anhydrous methylene chloride. The reaction was cooled in an ice bath and 72 mL (0.52 mol) of triethylamine and 1.0 g dimethylaminopyridine were added. 55 mL (0.38 mol) diethylchlorophosphoryl chloride was dissolved in 150 mL of anhydrous methylene chloride and added to the addition funnel. This solution was added dropwise to the reaction mixture over a period of 90 min. The reaction was then allowed to warm to ambient temperature overnight and was then quenched by the addition of 400 mL of saturated NaHCO₃ solution. The mixture was transferred to a separatory funnel and the layers were separated. The organic portion was washed successively with 5% NaH₂SO₄ solution (2×400 mL), water and brine. The organic layer was dried over Na₂SO_{4,} filtered and concentrated under reduced pressure to give 94.6 g of the desired product as a slightly purple liquid. The product was analyzed by proton NMR to confirm the molecular structure.

### Preparation of Flame Retardant Adhesives and Tapes

The exemplary flame retardant copolymers, adhesives, and tapes of the invention were prepared using methods known in the art, using the materials listed in Table 1.

TABLE 1
MATERIALS USED

| Product Name | Description | Source |
|---|---|---|
| Isooctyl acrylate (IOA) | Low T_{g} monomer | Sartomer, USA |
| 2-Octyl Acrylate (2OA) | Low T_{g} Monomer | Prepared as Described in |
| | | U.S. Pat. No. 7,385,020 |
| | | for Preparative Example 1 |
| Acrylic acid (AA) | High T_{g} monomer | Sartomer, USA |
| Isobornyl acrylate | High T_{g} Monomer | San Esters Corporation, |
| (IBXA) | | USA |
| Phosphoric acid 2- | Phosphate- | Sigma-Aldrich, USA |
| hydroxyethyl | Containing | |
| methacrylate | Monomer | |
| ester (PHME) | | |
| 2,2″-azobis (2- | Thermal Initiator | DuPont, USA |
| methylbutyronitrile) | | |
| (AMBN)—VAZO 67 | | |
| Benzyl dimethyl ketal— | Photoinitiator | BASF, USA |
| IRGACURE 651 | | |
| 2-hydroxy-2-methyl-1- | Photoinitiator | BASF, USA |
| phenyl-1-propane | | |
| (DAROCUR 1173) | | |
| Ethyl acetate (EtOAc) | Solvent | Sigma-Aldrich, USA |
| 1,6-Hexanediol | Crosslinking | DuPont, USA |
| Diacrylate (HDDA) | Agent | |
| T10 | Release Liner | Solutia, USA |
| T50 | Release Liner | Solutia, USA |
| HOSTAPHAN | Tape Backing | Mitsubishi Polyester |
| 3SAB PET | | Film, USA |

### Solvent Polymerization of Copolymers

Amounts of each monomer used in the polymerization of comparative examples and illustrative examples are presented in Table 2. IOA and AA monomers were added to a 100-g size glass bottle in the amounts indicated in Table 2. Quantities of the appropriate phosphate-containing monomer (DEPEA or DEPEMA, prepared as described previously) as listed in Table 2 were added to the IOA/AA mixture and all monomers were then mixed in ethyl acetate solvent. About 0.4 phr (parts per hundred total monomers) thermal initiator VAZO 67 was added. Solid content for the whole mixture was approximately 40% by weight. After the mixture was homogeneously mixed, it was deoxygenated using nitrogen (N₂) gas. The bottle was then sealed and secured in a cage holder. The cage holder was submerged in water in a Launder-Ometer at 60° C. and was rotated for 24 hours. After 24 hours, the bottle was cooled to room temperature before coating on PET backing film. The coated film was dried in the oven at 70° C. for 15 minutes. Adhesive samples were conditioned at 25° C. and 50% constant relative humidity (RH) overnight prior to testing.

Solvent polymerized adhesive formulations were coated from toluene solution onto a 1.2 mil (0.0012 inch, 0.030 mm) thick PET backing by knife coater targeting a dry coating thickness of approximately 1.5 mils (38 microns, μm). The coatings were dried at 70° C. for 15 min and the tape samples were then stored in a constant temperature (25° C.) and constant humidity (RH 50%) room for conditioning.

### Bulk Polymerization of Copolymers and Homopolymers

To prepare copolymer from DEPEA and DEPEMA copolymers, monomers were added to an 8-ounce jar in the amounts indicated in Table 2. About 0.04 phr of IRGACURE 651 was added. After IRGACURE 651 was dissolved, the mixture was deoxygenated and then exposed to a low power (less than 10 millliWatts/square centimeter) UV-A ultraviolet light using a blacklight bulb. Such bulbs are referred to as UV-A bulbs because their output occurs primarily between about 320 and 390 nanometers with a peak emission at around 350 nanometers in what is referred to as the UV-A spectral region. The mixture was exposed until a pre-adhesive polymeric syrup was formed having a Brookfield viscosity of about 1800 cps as measured by using a Brookfield Viscometer. Air was then introduced into the syrup.

Another 0.19 g of IRGACURE 651 and 0.08 phr of HDDA crosslinker was then added to the viscous mixture. The mixture was then knife-coated at about 1.5 mils (0.038 mm) gap between a 1.2 mil (0.0012 inch, 0.030 mm) thick PET backing and a silicone release liner. The coating was then exposed to UV lamp for 8 minutes to effect the polymerization to yield an acrylic pressure sensitive adhesive between the PET backing and the silicone release liner. Adhesive samples were conditioned at 25° C. and 50% RH overnight prior to testing.

TABLE 2
DESCRIPTION OF IOA/AA/DEPEA AND
IOA/AA/DEPEMA COPOLYMERS

| | | | | Amount of | |
|---|---|---|---|---|---|
| | | | | Phosphate- | |
| | Phosphate- | Amount | Amount | Containing | |
| | Containing | of IOA | of AA | Monomer | Polymerization |
| Ex. # | Monomer | (wt %) | (wt %) | (wt %) | Method |
| 1 | DEPEA | 60.13 | 3.16 | 36.71 | solvent |
| 2 | DEPEA | 48.72 | 2.56 | 48.72 | solvent |
| 3 | DEPEMA | 58.28 | 3.07 | 38.69 | solvent |
| 4 | DEPEMA | 46.12 | 2.43 | 51.46 | solvent |
| 5 | DEPEA | 60.13 | 3.16 | 36.71 | bulk |
| 6 | DEPEA | 64.29 | 7.14 | 28.57 | bulk |
| 7 | DEPEA | 62.07 | 6.90 | 31.03 | bulk |
| 8 | DEPEA | 60.00 | 6.67 | 33.33 | bulk |
| 9 | DEPEA | 58.16 | 6.45 | 35.48 | bulk |
| 10 | DEPEA | 56.25 | 6.25 | 37.50 | bulk |
| CE1 | DEPEA | 71.97 | 3.79 | 24.24 | solvent |
| CE2 | DEPEMA | 70.37 | 3.70 | 25.93 | solvent |
| CE3 | DEPEA | 0 | 0 | 100 | bulk |
| CE4 | DEPEMA | 0 | 0 | 100 | bulk |
| CES | none | 90 | 10 | 0 | bulk |
| CE6 | none | 95 | 5 | 0 | solvent |

Amounts of each monomer used in the polymerization of illustrative examples comprising PHME and corresponding comparative examples are presented in Table 3.

For Example 11, an 8 ounce jar was charged with 76 g of 20A, 24 g of IBXA, and 0.04 g of DAROCUR 1173. The solution was purged with nitrogen (N₂) for 2 minutes, then exposed to low power (less than 10 milliWatts/square centimeter) UV-A ultraviolet light using a blacklight bulb. The mixture was exposed until a prepolymer syrup was formed having a Brookfield viscosity of about 500-5,000 cP was formed. To the prepolymer syrup, 0.16 g of DAROCUR 1173 and 34 g of PHME were added and the solution was rolled overnight to ensure thorough mixing. The solution was then coated at 2 mil thickness between 1 mil (0.001 inch, 0.025 mm) thick PET and T10 release liner, and exposed to 1465 mJ/cm² of UVA light over approximately 10 minutes to prepare a sample for UL510 testing. For adhesive properties testing, the solution was coated at 2 mil (0.002 inch, 0.051 mm) thickness between T10 and T50 release liner and cured under the same conditions. Adhesive film was then laminated to 2 mil (0.051 mm) thick PET to form tapes. The release liner was removed prior to testing.

For Example 12 and Comparative Examples CE7-CE10, a prepolymer syrup was prepared as follows. A quart jar was charged with 418 g (76% by weight) of 2-octyl acrylate (20A), 132 g (24 wt %) of isobornyl acrylate (IBXA), and 0.22 g (0.04 wt %) of DAROCUR 1173. The solution was purged with nitrogen for 5 minutes and then exposed to low power UV-A radiation until a coatable prepolymer syrup (500-5,000 cP) was formed.

For Example 12, a small jar was charged with 30 g of the above prepolymer syrup, 11.25 g of PHME, 0.048 g of DAROCUR 1173, and the quantity of REGALREZ 6108 listed in Table 3. Jars were rolled overnight to ensure thorough mixing. Subsequently, samples were coated between T10 and T50 release liners at 2 mil (0.051 mm) thickness and exposed to 1293 mJ/cm² of UVA light over approximately 10 minutes. One of the release liners was then removed. Pressure sensitive adhesive samples were then laminated to 2 mil (0.051 mm) thick PET to form tapes for adhesive properties testing and 1 mil (0.025 mm) thick PET for testing in UL510. Subsequent to testing, the second release liner was removed.

For Comparative Examples CE7-CE10, each of four small jars were charged with 30 g of the above prepolymer syrup, 7.5 g of PHME, 0.048 g of DAROCUR 1173, and the quantity of REGALREZ 6108 listed in Table 3. Jars were rolled overnight to ensure thorough mixing. Subsequently, samples were coated between T10 and T50 release liners at 2 mil (0.051 mm) thickness and exposed to 2640 mJ/cm² of UVA light over approximately 3 minutes. One of the release liners was removed. Pressure sensitive adhesive samples were then laminated to 2 mil (0.051 mm) thick PET to form tapes for adhesive properties testing and 1 mil (0.025 mm) thick PET for testing in UL510. Subsequent to testing, the other release liner was removed.

For CE 11-14, each of four small jars were charged with 30 g of the above prepolymer syrup, 13 g of PHME, 0.048 g of Darocur 1173, and the quantity of Regalrez 6108 listed in Table 3. Jars were rolled overnight to ensure thorough mixing. Subsequently, samples were coated between T10 and T50 release liners at 2 mil thickness and exposed to 1973 mJ/cm² of UVA light over approximately 15 minutes. Pressure sensitive adhesive samples were then laminated to 2 mil thick PET to form tapes for adhesive properties testing and 1 mil thick PET for testing in UL510.

TABLE 3
DESCRIPTION OF ADHESIVES CONTAINING 2OA/IBXA/PHME COPOLYMERS

| | Copolymer Composition | | | | Adhesive Composition | | |
|---|---|---|---|---|---|---|---|
| | | | | Amount of | | Amount of | Amount of |
| | Amount of | Amount of | Amount of | DAROCUR | Amount of | REGALREZ | REGALREZ |
| | 2OA | IBXA | PHME | 1173 | Copolymer | 6108 | 6108 |
| Ex. # | (wt %) | (wt %) | (wt %) | (phr) | (wt %) | (g) | (wt %) |
| 11 | 56.7 | 17.9 | 25.4 | 0.15 | 100.0 | 0.0 | 0.0 |
| 12 | 50.2 | 15.9 | 24.8 | 0.13 | 90.1 | 4.1 | 9.1 |
| CE7 | 60.7 | 19.2 | 20.0 | 0.16 | 100.0 | 0.0 | 0.0 |
| CE8 | 58.5 | 18.5 | 19.2 | 0.15 | 96.2 | 1.5 | 3.8 |
| CE9 | 56.3 | 17.8 | 18.5 | 0.15 | 92.6 | 3.0 | 7.4 |
| CE10 | 54.3 | 17.1 | 17.9 | 0.14 | 89.3 | 4.5 | 10.7 |
| CE11 | 53.0 | 16.7 | 30.2 | 0.14 | 100.0 | 0.0 | 0.0 |
| CE12 | 51.2 | 16.2 | 29.2 | 0.13 | 96.6 | 3.4 | 1.5 |
| CE13 | 49.55 | 15.65 | 28.3 | 0.13 | 93.5 | 6.5 | 3.0 |
| CE14 | 48.0 | 15.16 | 27.37 | 0.13 | 90.5 | 9.5 | 4.5 |

### Test Methodologies

### Peel Adhesion Strength

This test measures the force required to peel from a substrate at at a specific angle and rate of removal. The test was performed on conditioned tapes prepared in the examples using the procedure described in the referenced ASTM Test Method ASTM D3330/D3330M-04, “Standard Test Method for Peel Adhesion of Pressure-Sensitive Tape” using a stainless steel substrate unless otherwise indicated.

Each test sample was prepared by adhering a 0.5 inch (1.27 cm) wide tape (prepared as described above) to a stainless steel plate and rolling over the tape once with a 2 kg roller. Peel adhesion strength was measured at a 180° peel angle using an IMASS SP-200 slip/peel tester (available from IMASS, Inc., Accord MA) at a peel rate of 12 inches/min (30.5 cm/min). Two or four samples were tested for each example. Values were measured in ounces per half inch (oz/0.5 in) and N/cm and reported as an average.

### Shear Strength

The static shear strength of the adhesive tapes of the present invention was also measured. The test was performed on conditioned tapes prepared in the examples using the procedure described in the referenced ASTM Test Method ASTM D-3654/D 3654M 06, “Standard Test Methods for Shear Adhesion of Pressure-Sensitive Tapes” using the variations described below. Stainless steel plates were prepared for testing by cleaning with methyl ethyl ketone and a clean KIMWIPE tissue (Kimberly-Clark, USA) three times. The end of the tape was adhered to a stainless steel plate, suspended at a 90 degree angle from horizontal, and a weight was attached to the free end of the tape. Tests were run either at room temperature (RT, 23° C.) or at elevated temperature (70° C.). Multiple specimens of each tape (adhesive film strip) were tested and the shear strength tests were averaged to obtain the reported shear values

70° C. Shear Test: A test sample was prepared from the conditioned tapes prepared in the examples. A 0.5 inch (1.27 cm) wide tape was adhered to one edge of a stainless steel plate so it overlapped the panel by 1 inch (2.54 cm), and a 2-kg roller was rolled twice over the portion of the tape adhered to the panel. A 0.5 kg load was attached to the free end of the tape, and the panel was suspended at a 90 degree angle from horizontal in an oven set at 70° C. The time, in minutes, for the tape to pull away from the panel was measured and the time to failure and the mode of failure was recorded. Possible failure modes are “adhesive (a)” in which the adhesive pulls away cleanly from the panel of the tape backing or “cohesive (c)” in which the adhesive splits and part of the adhesive is left on the tape and part is left on the tape backing. The test was terminated if failure had not occurred in 10,000 minutes and the result was recorded as “10,000 minutes.”

Room Temperature Shear Test: A test sample was recorded and tested in the same manner as for 70° C. Shear except that a 1 kg weight was attached to the tape and the test panel was suspended in a controlled environment room (23° C/50% Relative Humidity).

### UL510 Flammability Test

The samples were tested according to the UL510 flammability/burn test. Each tape sample was wrapped on a steel rod and exposed to an open flame for a period of fifteen seconds. Upon exposure to the flame, any flame on the test specimen (which typically catches fire) must extinguish in less than 60 seconds to pass the test. The test was repeated five times. Any extinguishing time longer than 60 seconds was considered a failure for the specimen. Results are reported below as “Pass” or “Fail.” In addition, no dripping should be observed, and a Kraft-paper flag placed near the top of the rod should not catch fire. Further information regarding the test may be found in the description of the UL 510 standard published by Underwriters Laboratory of Northbrook, Illinois, USA.

### Microscale Combustion Calorimetry

The samples were evaluated using Microscale Combustion Calorimetry (MCC) following the Method A protocol of ASTM D7309-07, “Standard Test Method for Determining Flammability Characteristics of Plastics and Other Solid Materials Using Microscale Combustion Calorimetry.” The instrument used was a Govmark MCC model MCC-2. The general method involves heating a 1-5 mg sample at a rate of 1 ° K/sec in a nitrogen environment. The decomposition products were fully oxidized in a combustion chamber held at 900 ° C. in a 20% oxygen and 80% nitrogen environment. The heat release of the decomposition gases is determined from the mass of oxygen used to completely combust the sample. Three runs for each sample were evaluated and the results averaged. The specific heat release h_{c} (kJ/g) was calculated from the data as the net heat release over the entire temperature range. Specific heat release is an analytical measurement of the flammability response of a burning polymer: a relatively high specific heat release indicates a polymer that burns relatively easily, whereas a relatively low specific heat release is indicative of a polymer that is relatively more resistant to burning.

RESULTS

### Adhesive Properties

Adhesive properties of IOA/AA containing flame retardants DEPEA and DEPEMA PSAs to stainless steel (SS) are shown in Tables 4 and 5, and results for adhesives containing 20A/IBXA/PHME copolymers are provided in Table 6.

TABLE 4
PEEL ADHESION TEST RESULTS OF
IOA/AA/DEPEA AND IOA/AA/DEPEA COPOLYMERS

| | Adhesive | | | | |
|---|---|---|---|---|---|
| | Thickness | | | | Failure |
| Ex. # | mil | mm | oz/0.5″ | N/cm | Mode |
| 1 | 1.2 | 0.030 | 37.9 | 8.30 | cohesive |
| 2 | 1.0 | 0.025 | 23.4 | 5.12 | cohesive |
| 3 | 1.1 | 0.028 | 23.2 | 5.08 | cohesive |
| 4 | 1.1 | 0.028 | 24.4 | 5.34 | cohesive |
| 5 | 1.5 | 0.038 | 4.2 | 0.92 | adhesive |
| CE1 | 1.2 | 0.030 | 44.8 | 9.81 | cohesive |
| CE2 | 1.1 | 0.028 | 26.8 | 5.87 | cohesive |
| CE6 | 1.1 | 0.028 | 71.2 | | cohesive |

TABLE 5
SHEAR ADHESION TEST RESULTS OF
IOA/AA/DEPEA AND IOA/AA/DEPEA COPOLYMERS

| | Room Temperature | | | |
|---|---|---|---|---|
| | (23° C.) | | 70° C. | |
| Ex. # | min | failure mode | min | failure mode |
| 1 | 109 | cohesive | 31 | cohesive |
| 2 | 81 | cohesive | 30 | cohesive |
| 3 | 2 | cohesive | 88 | cohesive |
| 4 | 2 | cohesive | 0 | cohesive |
| 5 | 9338 | adhesive | 10,000 | |
| CE1 | 121 | cohesive | 32 | cohesive |
| CE2 | 1 | cohesive | 1 | cohesive |
| CE6 | 1 | cohesive | 0 | cohesive |

TABLE 6
ADHESION TEST RESULTS OF
2OA/IBXA/PHME BASED ADHESIVES

| | Peel Adhesion | | Room Temperature |
|---|---|---|---|
| Ex. # | oz/in | N/cm | (23° C.) Shear (min) |
| 11 | 15.4 | 16.9 | 10,000+ |
| 12 | 20.6 | 22.5 | 7,064 |
| CE7 | 18.0 | 19.7 | 8,626 |
| CE8 | 22.2 | 24.3 | 8,016 |
| CE9 | 27.0 | 29.6 | 10,000+ |
| CE10 | 32.2 | 35.2 | 10,000+ |
| CE11 | 4.6 | 5.0 | 10,000+ |
| CE12 | 7.3 | 8.0 | 10,000+ |
| CE13 | 5.6 | 6.1 | 10,000+ |
| CE14 | 5.9 | 6.5 | 10,000+ |

### Flame Retardant Properties

Flame retardant properties of the phosphate-containing copolymer adhesives are shown below in Table 7. For some Examples and Comparative Examples, multiple replicates were tested, and results from each replicate are presented in Table 5.

TABLE 7
RESULTS OF UL 510 FLAME TEST

| | Extinguish Time, sec | | | | | Did Flag | |
|---|---|---|---|---|---|---|---|
| Ex. # | 1 | 2 | 3 | 4 | 5 | Burn? | Pass/Fail |
| 1 | 2 | 14 | 30 | 0 | 0 | N | Pass |
| 2 | 1 | 8 | 4 | 0 | 0 | N | Pass |
| 3 | 1 | 8 | 7 | 0 | 0 | N | Pass |
| 4 | 2 | 16 | 1 | 0 | 0 | N | Pass |
| 5 | 20 | 12 | 4 | 6 | 0 | N | Pass |
| 11 | 7 | 10 | 19 | 2 | 46 | N | Pass |
| 11 | 12 | 18 | 6 | 1 | 0 | N | Pass |
| 11 | 12 | 23 | 0 | 2 | 0 | N | Pass |
| 11 | 38 | 16 | 2 | 1 | 1 | N | Pass |
| 12 | 11 | 10 | 4 | 3 | 3 | N | Pass |
| 12 | 9 | 18 | 6 | 4 | 1 | N | Pass |
| CE1 | >60 | — | — | — | — | Y | Fail |
| CE2 | >60 | — | — | — | — | Y | Fail |
| CE5 | >60 | — | — | — | — | Y | Fail |
| CE6 | >60 | — | — | — | — | Y | Fail |
| CE7 | >60 | — | — | — | — | Y | Fail |
| CE7 | 19 | >60 | — | — | — | Y | Fail |
| CE8 | >60 | — | — | — | — | N | Fail |
| CE8 | >60 | — | — | — | — | Y | Fail |
| CE9 | 52 | >60 | — | — | — | Y | Fail |
| CE9 | 30 | >60 | — | — | — | Y | Fail |
| CE10 | 45 | >60 | — | — | — | Y | Fail |
| CE10 | 43 | 6 | 7 | 0 | 0 | N | Pass |

### MCC

Results of MCC measurements of flame retardant monomers DEPEA and DEPEMA are shown in Table 8 below along with MCC results for IOA/AA and IOA/AA/DEPEA copolymers. As seen in Table 8, presence of flame retardant reduces heat release in adhesives.

TABLE 8
SPECIFIC HEAT RELEASE

| | Specific Heat Release |
|---|---|
| Ex. # | (kJ/g) |
| 6 | 19.3 |
| 7 | 21.7 |
| 8 | 20.6 |
| 9 | 20.4 |
| 10 | 15.1 |
| CE3 | 10.1 |
| CE4 | 8.9 |
| CE5 | 26.7 |
| CE6 | 31.8 |

As can be seen in Table 8, the homopolymers of DEPEA and DEPEMA (CE1 and CE2, respectively) have lower specific heat release values then the copolymer of IOA/AA (CE3). The data in Table 8 also demonstrates that copolymers of IOA/AA and DEPEA (Examples 6-10) all demonstrate a lower specific heat release then copolymers of IOA/AA without the flame retardant monomer.

Flame retardant IOA/AA/Acrylic Phosphate and 20A/IBXA/Acrylic Phosphate adhesive compositions have been discovered which pass the UL510 flame test. The adhesive properties are tunable for suitable applications which require flame retardancy with balanced adhesive properties. Phosphate based flame retardant monomers of this invention are readily copolymerizable into acrylic adhesive systems to provide additional flame retardant properties in conjunction with pressure sensitive adhesive properties.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. This application is intended to cover any adaptations or variations of the preferred embodiments discussed herein. Therefore, it is manifestly intended that this invention be limited only by the claims and the equivalents thereof.

1. A halogen-free flame retardant adhesive comprising:
an acrylic copolymer preparable by polymerization of monomers comprising:
a first monomer which comprises a low glass transition temperature (Tg) monomer,
a second monomer which comprises a high Tg monomer, wherein at least one of the first and second monomers comprises a (meth)acrylate, and
a phosphate containing monomer
wherein the acrylic copolymer comprises from about 20 wt % to about 60 wt % of the phosphate-containing monomeric unit.

2. A flame retardant adhesive according to claim 1, wherein the acrylic copolymer comprises from about 30 wt % to about 80 wt % of the low Tg (meth)acrylic monomeric unit.

3. A flame retardant adhesive according to claim 1, wherein the first monomer comprises a (meth)acrylate-based monomer selected from the group consisting of 2-octyl acrylate, isooctyl acrylate, 2-ethyl hexyl acrylate, and combinations thereof

4. A flame retardant adhesive according to claim 1, wherein the acrylic copolymer comprises from about 1 wt % to about 40% of the high Tg (meth)acrylic monomeric unit.

5. A flame retardant adhesive according to calim 1, wherein the second monomer comprises a monomer selected from the group consisting of acrylic acid, acrylamide, isobornyl acrylate, and combinations thereof.

6. (canceled)

7. A flame retardant adhesive according to claim 1, wherein the phosphate containing monomer comprises a monomer represented by: 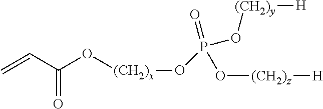
wherein x is an integer in the range between 1 to 5, inclusively; wherein y is an integer in the range between 0 to 5, inclusively; and wherein z is an integer in the range between 0 to 5, inclusively.

8. A flame retardant adhesive according to claim 7, wherein the phosphate containing monomer comprises diethoxyphosphoryloxyethyl acrylate (DEPEA).

9. A flame retardant adhesive according to claim 1, wherein the phosphate containing monomer comprises a monomer represented by: 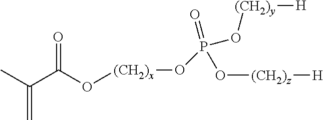
wherein x is an integer in the range between 1 to 5, inclusively; wherein y is an integer in the range between 0 to 5, inclusively; and wherein z is an integer in the range between 0 to 5, inclusively.

10. A flame retardant adhesive according to claim 9, wherein the phosphate containing monomer comprises diethoxyphosphoryloxyethyl methacrylate (DEPEMA).

11. A flame retardant adhesive according to claim 1, wherein the phosphate containing monomer comprises phosphoric acid 2-hydroxyethyl methacrylate ester (PHME).

12. A flame retardant adhesive according to claim 1, wherein the first monomer comprises an alcohol derived from a renewable source.

13. A flame retardant adhesive according to claim 1, wherein the adhesive comprises is a pressure-sensitive adhesive.

14. A flame retardant adhesive tape comprising the flame retardant adhesive according to claim 1 disposed on at least one major surface of a support layer.

15. A tape comprising a support layer having two opposed, major surfaces, and an adhesive disposed on at least one of the major surfaces of the support layer, wherein the adhesive comprises an acrylic copolymer preparable by polymerization of monomers comprising:
a first monomer which comprises a low glass transition temperature (Tg) monomer,
a second monomer which comprises a high Tg monomer, wherein at least one of the first and second monomers comprises a (meth)acrylate, and
a phosphate containing monomer.

16. An acrylic copolymer preparable by polymerization of monomers consisting of:
a first monomer which comprises a low glass transition temperature (Tg) monomer,
a second monomer which comprises a high Tg monomer, wherein at least one of the first and second monomers comprises a (meth)acrylate, and
a phosphate containing monomer,
wherein the acrylic copolymer comprises from about 20 wt % to about 60 wt % of the phosphate-containing monomeric unit.

17. An acrylic copolymer according to claim 16 comprising from about 40 wt % to about 80 wt % of the low Tg (meth)acrylic monomeric unit, wherein the first monomer comprises a (meth)acrylate-based monomer selected from the group consisting of 2-octyl acrylate, isooctyl acrylate, 2-ethyl hexyl acrylate, and combinations thereof.

18. (canceled)

19. An acrylic copolymer according to claim 16, comprising from about 1 wt % to about 8% of the high Tg (meth)acrylic monomeric unit,
wherein the second monomer comprises a monomer selected from the group consisting of acrylic acid, acrylamide, and isobornyl acrylate.

20. (canceled)

21. (canceled)

22. An acrylic copolymer according to claim 16, wherein the phosphate containing monomer comprises a monomer represented by: 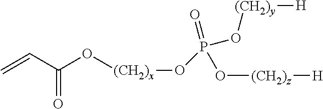
wherein x is an integer in the range between 1 to 5, inclusively; wherein y is an integer in the range between 0 to 5, inclusively; and wherein z is an integer in the range between 0 to 5, inclusively.

23. An acrylic copolymer according to claim 16, wherein the phosphate containing monomer comprises a monomer represented by: 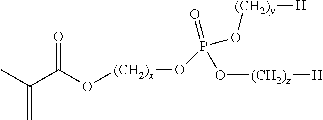
wherein x is an integer in the range between 1 to 5, inclusively; wherein y is an integer in the range between 0 to 5, inclusively; and wherein z is an integer in the range between 0 to 5, inclusively.
